(19) United States
(12) Patent Application Publication
(10) Pub. No.: US 2026/0117829 A1
(43) Pub. Date: Apr. 30, 2026

(54) DISC BRAKE CALIPER

(71) Applicant: BREMBO N.V., Bergamo (IT)

(72) Inventor: Fabio TROMBELLA, Bergamo (IT)

(73) Assignee: BREMBO N.V., Bergamo (IT)

(21) Appl. No.: 19/339,864

(22) Filed: Sep. 25, 2025

(30) Foreign Application Priority Data
Oct. 25, 2024 (IT) 102024000023865

(51) Int. Cl. F16D 65/00; F16D 55/00; F16D 65/18; F16D 121/04; F16D 121/18; F16D 125/40; F16D 127/06

(52) U.S. Cl. CPC F16D 65/0075; F16D 65/18; F16D 2055/002; F16D 2121/04; F16D 2121/18; F16D 2125/40; F16D 2127/06

(57) ABSTRACT

A disc brake caliper has a caliper body placed astride a brake disc having opposite friction surfaces, pads housed in the caliper body, a cylinder forming a cylindrical wall and a bottom wall, and a piston forming a side wall and a thrust wall. The piston, housed inside the cylinder, is configured to bias at least one of the pads against one of the friction surfaces. The disc brake caliper has a parking braking system having a screw-nut screw group having a screw element and a nut screw element. A rotation of the screw element corresponds to an axial translation of the nut screw element with respect to the caliper body, the nut screw element being configured to bias the piston and at least one of the pads against one of the friction surfaces. The nut screw element has a shield portion defining a piston chamber and a cylinder chamber.

### CROSS-REFERENCE TO RELATED APPLICATION

This application claims priority to Italian Patent Application No. 102024000023865 filed on Oct. 25, 2024, the contents of which are incorporated by reference in their entirety.

### FIELD OF THE INVENTION

The present invention relates to a disc brake caliper, in particular for a disc brake comprising an electromechanical parking brake.

### PRIOR ART

In recent years, the development of electromechanical parking brakes (EPBs) has focused on increasing their parking performance, both in terms of generated clamping force and service life.

In particular, current EPB devices are required to withstand at least 300,000 load cycles.

It has been highlighted that in order to increase the service life of an EPB device, and thus its number of load cycles, a proper fluid sealing of the braking system plays a fundamental role.

Unwanted brake fluid leaks and undesired ingress of air from the outside cause deterioration of EPB devices.

Indeed, in the absence of proper sealing, the brake fluid may enter in the gear motor chamber of the EPB device and damage its operation, for example by causing swelling of the plastic gears or a short circuit of the motor.

Furthermore, due to the loss of optimal sealing, the consequent brake fluid seepage generates a vicious circle that further reduces the life of EPB devices.

To address these issues, current EPB devices are generally provided with a seal, or more than one seal, of the O-ring type, sometimes paired with a back-up ring configured to prevent extrusion of the O-ring rubber caused by the high pressures of the brake fluid.

This known solution is not optimal since the resulting fluid sealing depends heavily on the compression of the O-ring within the seat in which it is housed.

Moreover, since the O-ring is mounted directly on the screw shaft of the EPB device, the relative sliding and heat generated during screw actuation cause significant wear and abrasion of the O-ring. The wear of the O-ring causes a significant reduction in its compression, causing brake fluid leakage and reducing the caliper life.

A further problem caused by the wear of the O-ring and its resulting loss of compression is represented by the ingress of air during the brake actuation step in the absence of pressurized brake fluid.

In fact, actuating the brake without the application of pressurized fluid causes the movement of the brake piston to generate a negative pressure at the EPB screw.

In the presence of a worn sealing system, the negative pressure causes air suction from the outside, and leads to a spongy feeling at the pedal, reducing braking performance.

Attempts have been made to solve these issues and increase the system sealing by placing several O-rings side by side.

However, placing multiple O-rings within the same seat has not proven effective because it does not solve the issues related to the high pressures of the brake fluid acting on the plurality of O-rings, which result in brake fluid seepage of brake fluid beyond the side-by-side O-rings.

### SUMMARY OF THE INVENTION

The purpose of the present invention is to provide a disc brake caliper comprising an improved parking braking system, and configured to overcome at least some of the drawbacks highlighted in the prior art.

These and other purposes are achieved by a disc brake caliper as described and claimed herein.

Preferred and advantageous embodiments of the present invention are also described.

### FIGURES

To better understand the invention and appreciate its advantages, some exemplary and non-limiting embodiments will be described hereinbelow, with reference to the accompanying figures, in which:

FIG. 1 is a perspective view of a disc brake caliper, along an axial section, according to a first embodiment of the present invention;

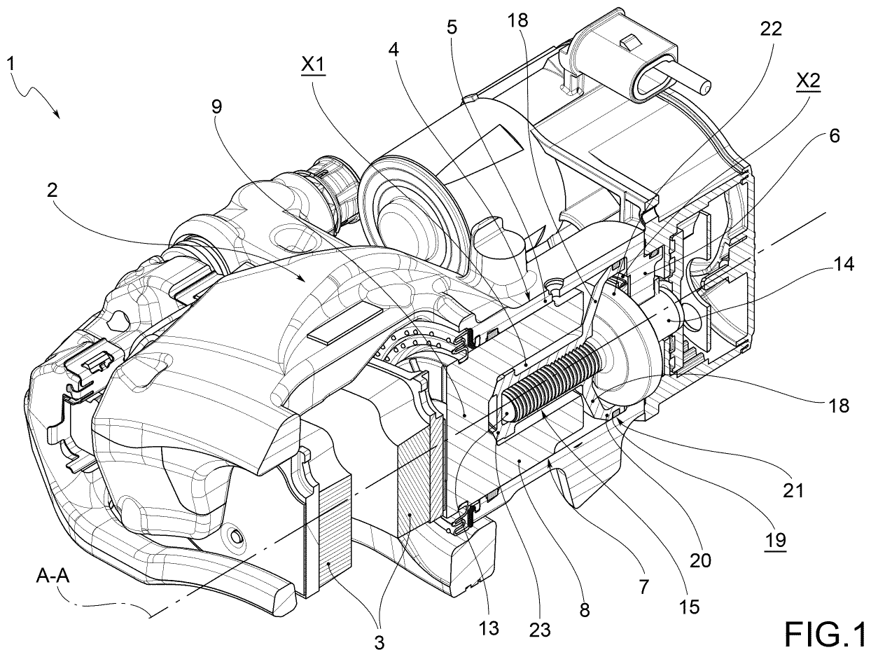

FIG. 2 is a side view of the disc brake caliper shown in FIG. 1;

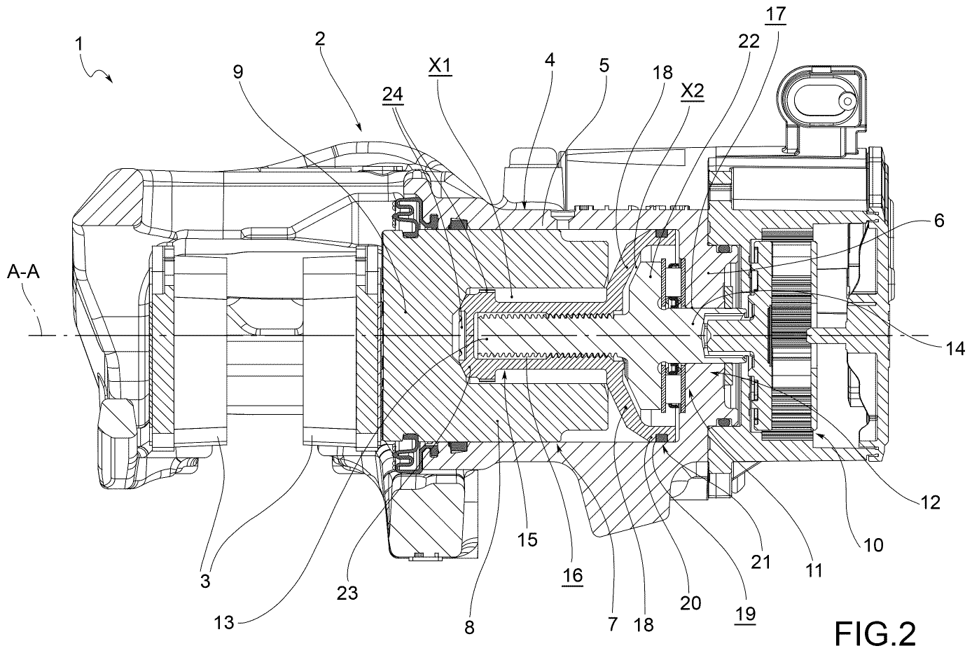

FIG. 3 is a partially sectioned perspective view of a nut screw element comprised in the disc brake caliper of FIG. 1; and

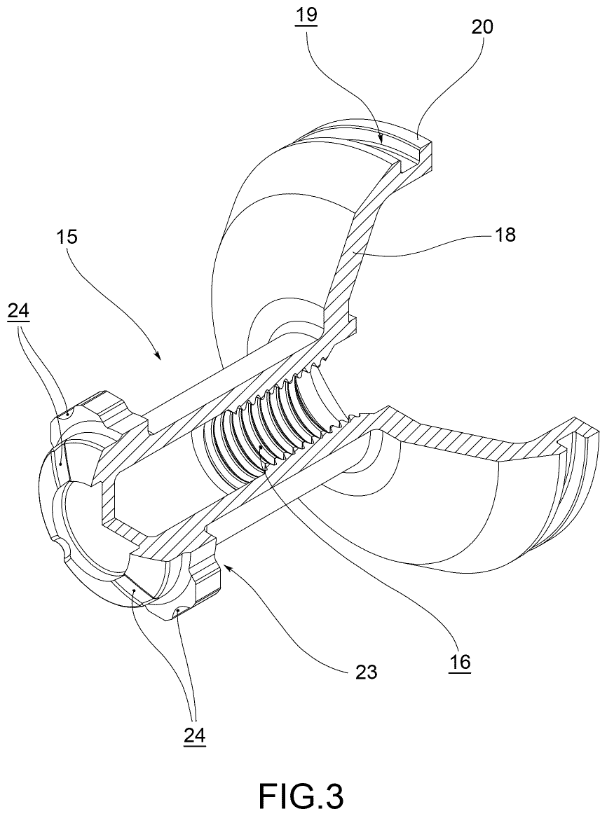

FIG. 4 is a sectional side view of the nut screw element of FIG. 3.

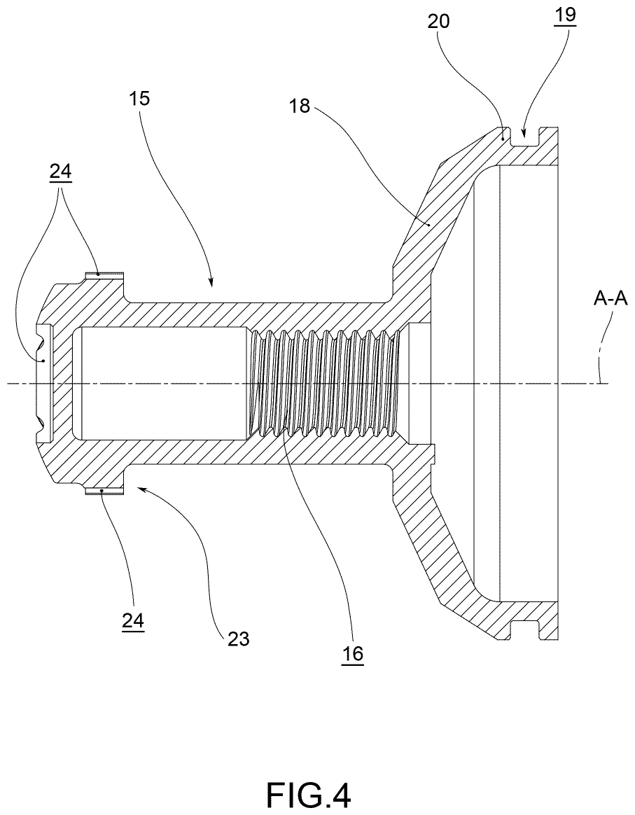

### DETAILED DESCRIPTION

With reference to the figures, a disc brake caliper is generally denoted by the reference number 1.

The disc brake caliper 1 comprises a caliper body 2 placed astride a brake disc having a rotation axis which defines an axial direction A-A, and opposite friction surfaces.

The disc brake caliper 1 comprises pads 3 housed in the caliper body 2 so as to be able to slide substantially in the axial direction A-A of the brake disc to act respectively on the opposite friction surfaces.

Furthermore, the disc brake caliper 1 comprises a cylinder 4, which forms a cylindrical wall 5 and a bottom wall 6 transverse to the cylindrical wall 5.

The disc brake caliper 1 further comprises a piston 7, which forms a side wall 8 and a thrust wall 9 substantially transverse to the side wall 8 and opposite to the bottom wall 6 of the cylinder 4.

The piston 7 is housed inside the cylinder 4, and the side wall 8 of the piston 7 is suitable for sliding within the cylindrical wall 5 of the cylinder 4.

The piston 7 is configured to be actuated by pressurized brake fluid injectable into the cylinder 4, so as to bias at least one of the pads 3 against one of the friction surfaces of the brake disc, along a thrust direction substantially parallel to the axial direction A-A.

The disc brake caliper 1 further comprises a parking braking system 10 which comprises a rotating member.

The rotating member is rotatably housed within a rotation seat 17 formed in the bottom wall 6 of the cylinder 4, so that the rotating member is rotatable about a rotation axis substantially parallel to the axial direction A-A.

According to one embodiment, the rotating member comprises an axial locking ring 22. Preferably, the axial locking ring 22 is a flange which extends radially.

The axial locking ring 22 extends in a radial direction and is adapted to provide an abutment which engages the surface of the bottom wall 6. According to a preferred embodiment, the engagement between the axial locking ring 22 and the surface of the bottom wall 6 is direct. According to a preferred embodiment, the engagement between the axial locking ring 22 and the surface of the bottom wall 6 is indirect, for example with a bearing positioned between the two components.

According to one embodiment, the parking braking system 10 comprises a screw-nut screw group 11 formed by a screw element 12 and a nut screw element 15.

According to a preferred embodiment, the rotating member constitutes the screw element 12.

In other words, it is the screw element 12 that extends rotationally free.

A rotation of the screw element 12 corresponds to a translation of the nut screw element 15, with respect to the caliper body 2, along a direction parallel to the axial direction A-A.

The nut screw element 15 is configured to bias at least one of the pads 3 against one of the friction surfaces of the brake disc.

According to a preferred embodiment, the screw-nut screw group 11 defines a thread and the thread is of the irreversible type. Advantageously, this configuration drastically reduces the seepage of brake fluid beyond the screw element 12, preserving the correct functionality of the other components of the EPB device.

In accordance with the present invention, the screw element 12 comprises a threaded end 13 housed inside a threaded cavity 16 of the nut screw element 15.

According to a preferred embodiment, the threaded cavity 16 is blind. In other words, the screw element 12 interacts via the threading with the nut screw element 15. That is to say that the screw element 12 does not have direct interactions with the piston 7.

Moreover, the screw element 12 comprises a control end 14 housed within a rotation seat 17 formed in the bottom wall 6.

In accordance with the present invention, the nut screw element 15 further comprises a shield portion 18.

The shield portion 18 defines a piston chamber X1 facing the thrust wall 9, preferably containing brake fluid, and a cylinder chamber X2 facing the bottom wall 6, containing air or lubricating fluid preferably at ambient pressure.

In other words, within the space between the cylinder 4 and the piston 7, the shield portion 18 is positioned so as to separate a piston chamber X1, in which the brake fluid is contained and which, when pressurized, performs the thrust action, and a cylinder chamber X2 in which air or lubricant is contained, preferably not pressurized or at ambient pressure.

Thanks to the presence of the shield portion 18, therefore, the components in the cylinder chamber X2 or facing the cylinder chamber X2 are spaced apart and are not influenced by the pressurized brake fluid.

In other words, the shield portion 18 prevents leakages, or minimizes possible leakages, by defining two distinct chambers, mutually separated.

According to a preferred embodiment, the shield portion 18 comprises an outer annular seat 19 made on an outer surface 20.

Preferably, the shield portion 18 comprises an outer seal 21 housed in the outer annular seat 19 to sealingly engage the cylindrical wall 5.

According to a preferred embodiment, the outer annular seat 19 has a substantially square section.

According to a preferred embodiment, the outer seal 21 is a square section seal.

As previously mentioned, preferably, the screw element 12 comprises an axial locking ring 22 which extends in a radial direction and is suitable for providing an abutment engaging the bottom wall 6. The shield portion 18 is shaped to engage the cylindrical wall 5 in a region radially outside the axial locking ring 22.

Furthermore, according to a preferred embodiment, the shield portion 18 is shaped in such a way as to be spaced from the axial locking ring 22, extending radially so as to engage the cylindrical wall 5.

In accordance with a preferred embodiment, the nut screw element 15 and the piston 7 are mutually engaged so as to prevent reciprocal rotations.

Preferably, the nut screw element 15 and the piston 7 are coupled by shape coupling.

According to a preferred embodiment, the nut screw head 23 and the side wall 8 are coupled by shape coupling.

In accordance with a preferred embodiment, the nut screw element 15 and the shield portion 18 are made in one piece.

According to what has been stated above, the shape couplings are made in such a way as to allow the insertion (and possible translational movements) of the components along the axial direction A-A, while at the same time preventing possible rotational movements with respect to the axis.

According to a preferred embodiment, in the shape couplings, a free space is always left so that pressurized brake fluid can flow.

Preferably, according to a preferred embodiment, the disc brake caliper 1 comprises at least one fluid channel 24.

Preferably, the disc brake caliper 1 comprises a plurality fluid channels 24 angularly spaced apart.

According to a preferred embodiment, the fluid channels 24 comprise an axial section which extends substantially parallel to the axis.

According to a preferred embodiment, the fluid channels 24 comprise a radial section extending substantially radially with respect to the axis.

According to a preferred embodiment, the fluid channels 24 are made between the piston 7 and the nut screw element 15.

In accordance with a preferred embodiment, the fluid channels 24 are made between the piston 7 and the nut screw element 15, for example between the side wall 8 and the nut screw element 15.

Preferably, the nut screw element 15 is specifically shaped.

Preferably, the piston 7, i.e. the side wall 8 and/or the thrust wall 9, is specifically shaped.

Innovatively, the disc brake caliper object of the present invention fully achieves the intended purpose.

Advantageously, the disc brake caliper fully exploits the benefits associated with the screw-nut screw group, and thanks to the shield element prevents the brake fluid from reaching the screw element.

Advantageously, the nut screw element serves the purpose of receiving the action from the screw element to transmit it to the piston, while at the same time is suitable for protecting the screw element from the brake fluid.

Advantageously, the outer seal is a dynamic seal.

Naturally, those who are skilled in the art will be able to make modifications or adaptations to the present invention without however departing from the scope of protection as described and claimed herein.

What is claimed is:

1. A disc brake caliper comprising a caliper body arranged straddling a brake disc having a rotation axis defining an axial direction and opposite friction surfaces, the disc brake caliper comprising pads housed in the caliper body so as to slide in the axial direction with respect to the brake disc to act on the opposite friction surfaces, respectively,
the disc brake caliper comprising:
a cylinder forming a cylindrical wall and a bottom wall transverse to the cylindrical wall; and
a piston forming a side wall and a thrust wall transverse to the side wall and opposite to the bottom wall of the cylinder;
wherein the piston is housed inside the cylinder, and the side wall of the piston is suitable for sliding within the cylindrical wall of the cylinder;
wherein the piston is configured to be biased by a pressurized brake fluid injectable into the cylinder so as to bias at least one of the pads against one of the opposite friction surfaces of the brake disc, along a thrust direction substantially parallel to the axial direction;
the disc brake caliper further comprising a parking braking system that comprises a screw-nut screw group comprising a screw element and a nut screw element, wherein the screw element is rotational about a rotation axis substantially parallel to the axial direction and comprises a threaded end housed inside a threaded cavity of the nut screw element and a control end housed inside a rotation seat formed in the bottom wall, wherein a rotation of the screw element corresponds to an axial translation of the nut screw element with respect to the caliper body, the nut screw element being configured to bias the piston, and thus at least one of the pads against one of the opposite friction surfaces of the brake disc, and wherein the nut screw element comprises a shield portion that extends radially to engage the cylindrical wall and defines a piston chamber facing the thrust wall, and a cylinder chamber facing the bottom wall.

2. The disc brake caliper of claim 1, wherein the shield portion is shaped to be spaced apart from the screw element.

3. The disc brake caliper of claim 1, wherein the shield portion comprises an outer annular seat formed on an outer surface, and wherein the shield portion further comprises an outer seal housed in the outer annular seat to sealingly engage the cylindrical wall.

4. The disc brake caliper of claim 3, wherein the outer annular seat has a substantially square section.

5. The disc brake caliper of claim 3, wherein the outer seal is a square section seal.

6. The disc brake caliper of claim 1, wherein the screw element comprises an axial locking ring extending in a radial direction and adapted to provide an abutment which engages the bottom wall, and wherein the shield portion is shaped to engage the cylindrical wall in a region radially outside the axial locking ring.

7. The disc brake caliper of claim 1, wherein the nut screw element and the piston are mutually engaged so as to prevent mutual rotations.

8. The disc brake caliper of claim 7, wherein the nut screw element and the piston are coupled by shape coupling.

9. The disc brake caliper of claim 1, wherein the nut screw element and the shield portion are in one piece.

10. The disc brake caliper of claim 1, wherein the screw-nut screw group defines an irreversible-type thread.

11. The disc brake caliper of claim 1, wherein the piston chamber is pressurized.

12. The disc brake caliper of claim 1, wherein the cylinder chamber is at ambient pressure.
